(19) United States
(12) Patent Application Publication
(10) Pub. No.: US 2015/0130179 A1
(43) Pub. Date: May 14, 2015

(54) POLYMER BANK NOTE WITH OPTICAL SECURITY ASSEMBLY PROVIDING IN-SUBSTRATE FOCUSING

(71) Applicant: LUMENCO, LLC, ENGLEWOOD, CO (US)

(72) Inventor: MARK A. RAYMOND, LITTLETON, CO (US)

(21) Appl. No.: 14/529,549

(22) Filed: Oct. 31, 2014

Related U.S. Application Data
(60) Provisional application No. 61/902,024, filed on Nov. 8, 2013.

(51) Int. Cl. B42D 25/351

(52) U.S. Cl. CPC B42D 25/351
USPC 283/91

(57) ABSTRACT

An assembly adapted for use as a polymer bank note with optical-based security features. The apparatus includes a planar substrate formed of a thin layer or sheet of transparent polymer such as a polypropylene. The apparatus includes an image stack (e.g., multiple layers of ink and other materials) applied to a first side of the planar substrate. An optical security assembly is provided that includes an array of lenses on the first side of the planar substrate that extends on the first side adjacent to the image stack. The optical security assembly includes an image element, such as interlaced images, on a second side of the planar substrate opposite the lens array. The lenses are each configured to have a focal length corresponding to the thickness of the planar substrate and to focus at the second side upon a portion of the image element to provide “in-substrate focusing.”

### CROSS-REFERENCE TO RELATED APPLICATIONS

This application claims the benefit of U.S. Provisional Application No. 61/902,024, filed Nov. 8, 2013, which is incorporated herein by reference in its entirety.

### BACKGROUND

1. Field of the Description

This description is generally directed toward design of polymer bank notes (or currency) with optical security features, and, more particularly, to bank notes that include an optical security assembly particularly suited for minimizing height (or thickness) build up of the bank note, e.g., providing desirable focusing onto an interlaced image while having an overall thickness that matches the adjacent portions of the bank note.

2. Relevant Background

Polymer bank notes or currency are made from a plastic or polymer such as biaxially oriented polypropylene (BOPP), blown propylene film, or the like. A growing number of countries are considering or even converting from paper to polymer bank notes, with at least eight countries having fully converted to polymer bank notes by 2014. Lower costs are one reason for this conversion as the polymer substrate or body of the bank note makes this currency more durable and longer lived. However, anti-counterfeiting is another key reason that many countries are converting to polymer bank notes.

Security features that are provided on paper can also be provided on polymer bank notes. Additionally, though, new security features that cannot be provided with paper currency can be provided with polymer bank notes because the substrate or body of the bank notes can be provided to be transparent (herein, “transparent” is intended to mean translucent to transparent to light). Hence, a transparent window may be provided that is used to display a security image that allows the bank note to be authenticated. An optical security feature may take the form of a lens or lens array (e.g., a lenticular lens array, a diffraction grating, or the like) that is used to display an image printed on an opposite side of the transparent substrate (e.g., an interlaced image when the lens array is a lenticular lens array). The displayed or visible image may be a three dimensional (3D) image, an image that is animated with movement of the bank note (or with differing viewing angles), an image provided by a full volume pixel map or moiré pattern, and/or provide other optical effects available through the use of lenticular, diffraction, and other optical technologies. With the use of such optical security features, polymer bank notes are very difficult to counterfeit as the optical security features cannot simply be copied using scanning, photocopying, and other techniques used with some paper bank notes.

In many polymer bank notes, the security or anti-counterfeiting features is provided by a lens or lens array that is cast or embossed on the front or back of the bank note (or its transparent substrate or body) and by a corresponding image (e.g., a printed, embossed, holographic, or other image visible through the lens or lens array, which may be considered the image element or component) provided on the reverse side of the bank note. An ongoing challenge, however, is to provide adequate focusing with the lens or lens array onto the image to provide an in-focus image to a viewer through the lens or lens array. Presently, an existing design for the optical security feature provides lenses that are relative wide and focus at a point well beyond the reverse side of the bank note substrate where the image is provided such that the displayed or produced image appears out-of-focus to a viewer inspecting the authenticity of the bank note.

In this regard, most polymer bank notes have a thickness in the range of 65 to 100 microns. For example, some bank notes have a substrate or body that is 75 microns thick while ink and/or other deposited materials on its outer surfaces increase the overall thickness by about 10 to 20 microns such that the overall thickness of the bank note is 85 to 95 microns. The material thickness of the bank note substrate is relative fixed for each series of bank notes for a country, and a requirement for each optical security feature is that the thickness of the note at the optical security feature match that of the other portions of the bank note (e.g., the optical security feature that is made up of the lens array, the substrate thickness, and the ink or other material used to provide the image on the reverse side should be equal to or less than the adjacent portions of the note made up of the substrate or body along with layers of ink and/or other deposited materials adjacent to one or both sides of the lens array and its corresponding image).

There remains a need for improved optical security features for polymer bank notes that provides enhanced or improved focusing by the lens or lens array onto the reverse surface of the bank note substrate and the image element provided on this reverse surface. Preferably, bank notes with these improved optical security features would be inexpensive to manufacture while providing an acceptable overall thickness along the length of the note.

### SUMMARY

The inventor recognized that to improve anti-counterfeiting or security attributes of polymer bank notes (or currency) it is highly desirable to provide an optical security feature or assembly in the note that functions to properly focus on an opposite or back side of the note's substrate (or body, which may be “transparent” meaning the material is translucent to transparent to light) and an image element provided on this opposite side (e.g., upon a printed interlaced image). This may be thought of as providing “in-substrate focusing,” and such proper focusing may be achieved with a lens array (set of lenticules in some cases) fabricated according to the present description.

Further, the inventor recognized that the lens array of the optical security assembly can be provided on a surface of the note's transparent substrate with a height or “sag” that maintains an overall thickness of the polymer bank note that matches that of the surrounding portions of the note. More specifically, the height or sag of lenses in the lens array combined with the thickness of the bank note substrate and thickness of the image element (layer(s) of ink providing an interlaced image, for example) is equal to or less than adjacent portions of the note made up of layers of ink (and/or other material) on both sides of the substrate combined with the substrate's thickness. Stated differently the height or sag should be about equal to or less than the buildup of the ink and/or other material layers on the side of the node upon which the lens array is provided such as by casting or embossing.

This is important because if the height or sag of the lenses exceeds the thickness of the adjacent ink and/or other material layers (e.g., height or sag does not exceed about 20 microns in some embodiments) the bulge or “buildup” at the lens array or provided by the optical security assembly will be too great to allow the bank notes to work properly in a stack of bank notes such as in an automatic teller machine (ATM) or cash dispensing machine and also will make it difficult to process the bank notes through printing presses and converting equipment during manufacture of the polymer bank notes.

Further, the inventor understood that in order to achieve a proper 3D image, which is often desirable for imagery used for security features of currency, a minimum of 5 pixels are typically required at a reasonable resolution or dots-per-inch (DPI) that can be printed accurately on a polymer bank note. This further limits the mathematical range of possibilities to achieve an optimal image on a polymer bank note for a security feature with a lens or lens array having a minimum height or sag (e.g., a height or sag in the range of about 1 micron up to about 20 microns).

More particularly, an apparatus or assembly is provided for use as a bank note that has optical-based security features to limit or even prevent counterfeiting. The apparatus includes a planar substrate with a first side and a second side opposite the first side, and, the planar substrate is formed of a thin layer or sheet of transparent polymer such as a polypropylene. The apparatus includes an image stack comprising at least one ink layer applied to the first side of the planar substrate. Further, an optical security assembly (e.g., an optical-based security feature) is provided that includes a lens array with a plurality of lenses on the first side of the planar substrate.

The lens array extends on the first side adjacent to the image stack. The optical security assembly includes an image element on the second side of the planar substrate at a location opposite the lens array. In some embodiments, the planar substrate has a thickness (e.g., less than 100 microns such as 60 to 80 microns), and the lenses are each configured to have a focal length corresponding to the thickness of the planar substrate and to focus at the second side upon a portion of the image element. In this manner, the lens array provides in-substrate focusing rather than focusing at a point or location outside of the substrate or some distance past the second side of the substrate as with some prior polymer bank notes.

In many embodiments of the apparatus, the lenses each have a height less than a thickness of the image stack on the first side of the planar substrate, and the height may be less than about 20 microns such as in the range of 12 to 18 microns (with one embodiment using a height or sag of 12.5 microns). In some cases, the lenses each may have a chord width of less than 70 microns (e.g., such as 55 to 65 microns with a particular implementation having chord widths of 61 microns). The lenses may be round lenses, square lenses, hexagonal lens, elliptical lenses, and lenticules (or linear lenses with a circular, elliptical, or other cross sectional shape). To practice the apparatus (or a polymer bank note), the lenses may take the form of a plurality of lenticules provided at a pitch in the range of 380 to 2560 lenses per inch (LPI) (with an LPI of 419 used in one implementation).

Further, in some embodiments, the image element may include a plurality of pixels, and each of the lenses is configured to focus on at least five of the pixels (e.g., to provide a 3D image or animation). The lens array further may include a gap or spacing between each adjacent pair of the lenses, and a width (or size) of the gap is large enough to provide a relative focus of less than one fifth of a chord width (labeled 0.2 C in this description) of the lens at 0 degrees. In some particular implementations of the apparatus, the lenses are formed of the same transparent polymer as the substrate (e.g., are cast onto the first side or extruded with the substrate on the first side), and the transparent polymer may have a refractive of index in the range of 1.4 to 1.7 (such as 1.47 with the transparent polymer taking the form of a polypropylene (e.g., BOPP, blown propylene film (or “blown film” as it is sometimes referred to in the industry), or the like)) or other polymer.

### BRIEF DESCRIPTION OF THE DRAWINGS

FIG. 1 illustrates a schematic side view (or functional block drawing) of a polymer bank note including an optical security feature or assembly of the present description;

FIG. 2 is a top view of a polymer bank note with a security feature or optical security assembly of the present description;

FIG. 3 is a sectional view of the bank note of FIG. 2 taken at line 3-3;

FIG. 4 is a side or end view of a portion of an apparatus/assembly (e.g., a polymer bank note) showing details of an optical security feature or assembly; and

FIGS. 5, 5A, and 5B are side or end views of a portion of a bank note similar that shown in FIG. 4 but further including spaces or gaps between adjacent pairs of the lenses in the lens array of the optical security feature or assembly and also showing focusing in the range of −0.2 C to +0.2 C.

### DETAILED DESCRIPTION

Briefly, the present description is directed toward polymer bank notes that are fabricated so as to include an optical security feature or assembly, which is designed to provide “in-substrate focusing.” To this end, the optical security assembly includes a lens array on a first side or surface of a bank note substrate that is specially configured such that each lens when combined with the transparent (i.e., translucent to transparent to light) substrate or body of the bank note focus light passing through the lens upon a second or opposite side or surface of the transparent substrate or body. In the following description, polymer bank notes that include optical security assemblies are first discussed in more general terms, and then particular techniques for implementing optical security assemblies with in-substrate focusing are discussed in detail.

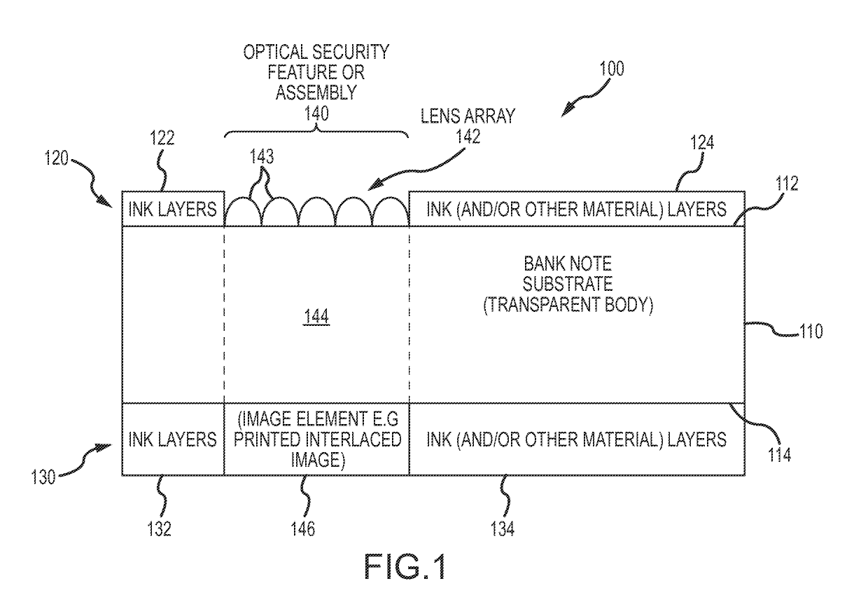

FIG. 1 illustrates schematically or with a functional block-type drawing a polymer bank note 100 of the present description. The bank note 100 is “polymer” in that it includes a body or substrate 110 is formed of a transparent plastic or polymer such as, but not limited to, a polypropylene such as BOPP. The note substrate 110 is formed from a thin sheet of the polymer or plastic such that the body is planar with first and second opposite sides or surfaces 112, 114, with many countries having currency that is rectangular in shape that is 2 to 3 inches in width by 4 to 6 inches in length. The substrate 110 is “thin” in that it typically will have a thickness (as measured between sides/surfaces 112 and 114) of about 70 to 85 microns with 75 microns being a common thickness for the transparent substrate 110.

The bank note 100 further includes materials including layers of ink and other compounds to provide imagery and information associated with the currency definition or design for the country. As shown, the note 100 includes an upper currency image stack 120 and a lower currency image stack 130 that are used to display imagery and data associated with the front and back of a particular currency run, e.g., the imagery may differ for each denomination of a country's currency and the imagery may be updated periodically (such as to show a different country leaders image). The upper currency image stack 120 is shown to include first and second sets of ink (and/or other material) layers 122 and 124, and, likewise, the lower currency image stack 130 is shown to include first and second sets of ink (and/or other material) layers 132 and 134. The layers 122, 124, 132, 134 may include a base layer (e.g., a layer of white ink) followed by several other layers to print differing colors of an image.

The techniques for applying the image stacks 120, 130 are well known in the currency industry and, hence, are not explained in detail herein. For this description, it is more relevant that the ink layers 122, 124, 132, 134 increase the overall thickness of the bank note, and this build up thickness can be used to provide a lens array 144 on one side 112 of the note substrate 110 and an image element (e.g., layers of ink providing a printed interlaced image) 146 on the opposite or second side 114 of the substrate 110 without bumps or bulges that could negatively affect later use and processing of the bank note 100. For example, the thickness of the ink layers 122, 124 (and also ink layers 132, 134) may be in the range of 7 to 25 microns with a thickness in the range of 10 to 20 microns and, in some cases, 12 to 18 microns being common in polymer bank notes presently in production. As discussed above, it is desirable to design the bank note 100 such that any security features are provided without increasing the overall thickness of the note 100 and without providing a bulge or bump at the location of any of the security features.

To this end, the bank note 100 is shown to include an optical security feature or assembly 140 that is adapted to have an overall thickness that matches or is less than the overall thickness of the note 100. Further, the assembly 140 is adapted to provide in-substrate focusing rather than providing focusing that is outside the substrate 110 (e.g., some prior notes focused a distance apart from either surface 112, 114 rather than on surface 114 as taught herein). Particularly, the assembly 140 includes a lens array 142 attached to or, more typically, formed upon the first or upper side (or surface) 112 of the note substrate 110. In some cases, the lens array 142 is cast or formed of the same material as the substrate 110, such as a transparent plastic or polymer (e.g., polypropylene or the like). The array 142 is made up of a plurality of lenses 143 such as lenticules that may have a circular, elliptical, hexagonal, square, or other cross-sectional shape. The assembly 140 also includes an image element 146, which may be a printed interlaced image 146 within interlacing of images corresponding with the lenticules/lenses 143 of array 142, and the image element 146 is provided on the second or lower side 114 opposite the lens array 142.

The optical security feature or assembly 140 further is shown to include a portion or segment 144 of the substrate 110 that is sandwiched or positioned between the lens array 142 and the image element 146. The lenses 143 of the array 142 are configured (as discussed below) so as to focus through the substrate portion 144 onto the back or second side 114 and the image element 146 provided there. The lens array 142 is shown to be positioned in the gap or space between the ink layers 122 and the ink layers 124 while the image element 146 is positioned in the gap or space between the ink layers 132 and the ink layers 134, with portions of the image element (such as a slice or stripe of an interlaced image) 146 being aligned or registered with one (or more) of the lenses 143 of the array 142.

Significantly, the lenses 143 are configured to have a height or sag that is equal to or less than the thicknesses of the adjacent ink layers 122, 124. Typically, the sets of ink layers 122 and 124 have substantially equal thicknesses, and these thicknesses may fall within the range of 7 to 25 microns, 10 to 20 microns, or 12 to 18 microns. The height or sag of the lenses 143 is measured from the surface 112 (or chord of the lenses 143) to the top of the lenses 143 (or top of an arc of a lens 143), and the height or sag of the lenses 143 is set to match or be less than the thickness of layers 122, 124. For example, the ink layers 122, 124 may provide a buildup or thickness in the range of 12 to 18 microns such as 15 microns, and the height or sag of the lenses 143 would be limited to 15 microns so that the overall thickness of bank note 100 does not exceed that defined by the ink layers 122, 124 combined with the substrate thickness and ink layers 132, 134.

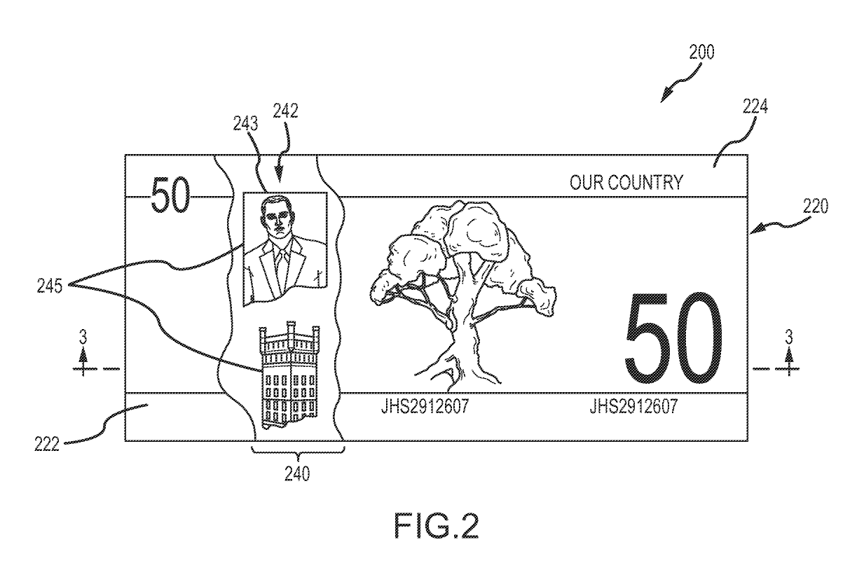

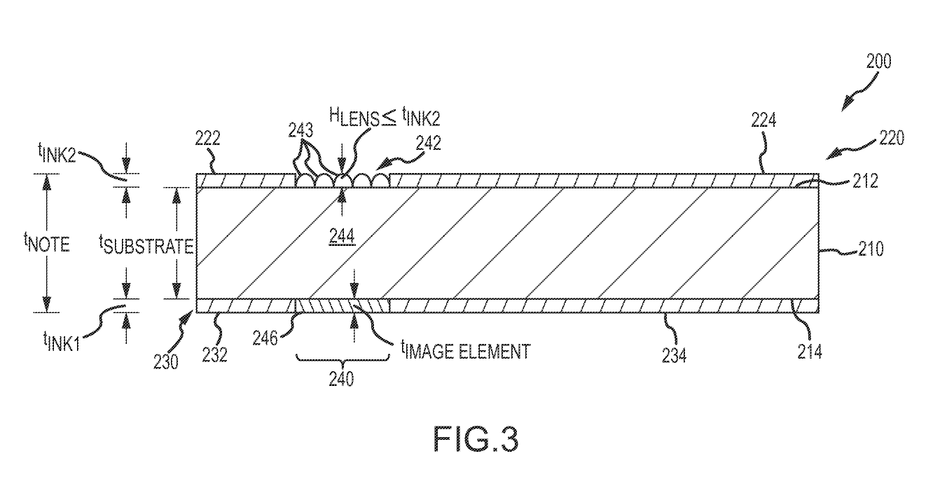

FIG. 2 illustrates at top view an exemplary polymer bank note 200 fabricated according to the present description with an optical security feature or assembly 240 that provides in-substrate focusing, and FIG. 3 is a sectional view of the note 200 of FIG. 2 (note, the sectional view is not shown to scale with the ink and lens arrays shown larger to facilitate illustration of these relatively thin layers or components). With reference to FIG. 2, the bank note 200 includes an optical security feature or assembly 240 with a lens array 242 providing a plurality of lenses 243 (e.g., lenticules or the like formed of a transparent material such as the polymer used for the substrate of the note 200), and the lenses 243 are used to focus light passing through the array 242 so as to display images 245 (e.g., 3D images, images with motion, and the like) that allow a viewer to verify the authenticity of the bank note 200. As shown in FIG. 2, the bank note 200 includes a first or upper image stack or assembly 220 made up of a first set of ink (and/or other material) layers 222 and a second set of ink (and/or other material) layers 224. A gap or space is provided between the two sets of layers 222, 224, with the lens array 242 positioned between the two sets of layers 222, 224.

With reference now to FIG. 3, the bank note 200 further includes a substrate 210 with an upper or first planar side or surface 212 and a second or lower planar surface 214 (opposite the first surface 212). The note 200 is a “polymer bank note” and, with this in mind, the substrate 210 typically will be formed of a transparent plastic or polymer such as a polypropylene or the like. The layers 222, 224 of the upper image stack 220 and the lens array 242 are provided or formed upon the upper side 212 of the substrate 210. The note 200 further includes a lower or second image stack 230 made up of a first set of ink (and/or other material) layers 232 and a second set of in (and/or other material) layers 234, which are both formed or provided on the second or lower side 214 of the substrate and are spaced apart a distance to provide a space or gap for receiving the image element 246. The layers 232, 234 are used to display a set of images and/or data (e.g., a back or reverse side of a denomination of a country's currency).

The optical security feature or assembly 240 further includes the image element 246, e.g., a plurality of interlaced images, and the image element 240 is formed or provided on the lower side 214 of the substrate at a location opposite the lens array 242. The lenses 243 are adapted to focus light through a portion or segment 244 of the transparent substrate 210 at focal points coinciding with the lower or second side 214 so as to provide in-substrate focusing upon the image element 246. In this example, with reference again to FIG. 2, the lenses 243 focus light onto the image element 246 that is then reflected back to a viewer to allow viewing of the images 245, which would be “in focus” for the viewer.

As discussed above, it is desirable for the optical security feature or assembly 240 to be provided not only to provide in-substrate focusing (e.g., with lenses having a focal point on or near the back side/surface 214 or a focal length of about the thickness, t_{substrate}, of the substrate 210) but to also not provide a bulge or increase in the overall thickness, t_{Note}, of the bank note 200. To this end, the overall thickness, t_{Note}, of the bank note 200 is defined by the thickness, t_{substrate}, of the substrate 210 (as measured between first and second sides/surfaces 212, 214) combined with the thicknesses of the deposited materials or buildups on the sides/surfaces 212, 214. The optical security assembly 240 has a thickness made up of the substrate thickness, t_{substrate}, combined with the thickness, t_{Image Element}, and the height, H_{Lenses}, of the lenses 243 of the lens array 242.

It is desirable to have this thickness match that of the adjacent portions of the note 200 as defined by the thickness, t_{Ink1}, of the ink layers 232, 234 and the thickness, t_{Ink2}, of the ink layers 222, 224 combined with the thickness, t_{Substrate}, of the substrate 210. To this end, the image element 246 can readily be provided with one or more layers of ink to have a thickness, t_{Image Element}, that matches the thickness, t_{Ink1}, of the lower image stack 230. Likewise, and more significantly, the lenses 243 of the array 242 are provided with a height, H_{Lenses}, that is equal to or less than the thickness, t_{Ink2}, of the upper image stack 220 (or the adjacent layers 222, 224 of ink or other deposited materials on side 212 of the substrate 210). For example, the thickness, t_{Ink2}, may be in the range of 12 to 18 microns and, the lenses 243 may be designed to each have a height, H_{Lenses}, that also falls in this range. In one implemented prototype, the thickness, t_{Ink2}, was in the range of 12 to 13 microns and the height, H_{Lenses}, was provided at 12.5 microns while providing in-substrate focusing (onto image element 246, which was provided at 508 LPI (lenticules or lenses per inch)).

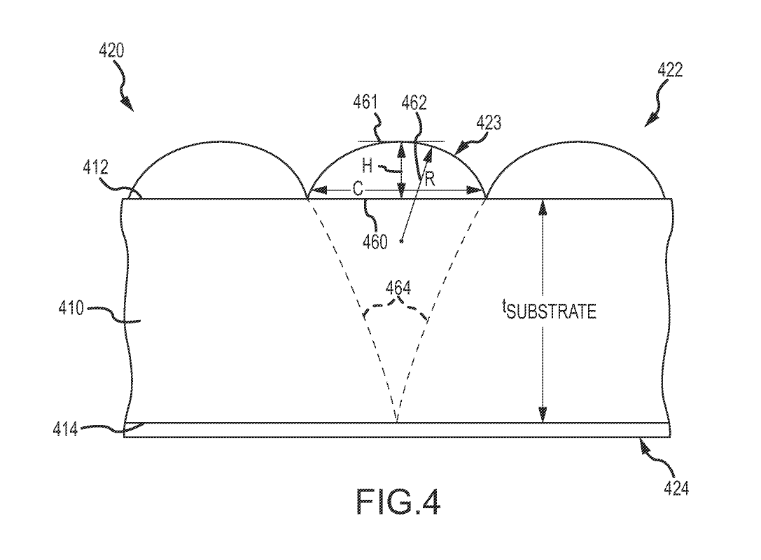

At this point in the description, it may be useful to discuss design of lenses for lens arrays to achieve in-substrate focusing. FIG. 4 illustrates an end or side view of a portion of an optical security feature or assembly 420 according to an embodiment of the present description. As shown, the assembly 420 is built upon a segment or portion of the substrate 410 of a polymer bank note (e.g., a thickness, t_{Substrate}, of a transparent polymer such as polypropylene), and the substrate 410 includes a first side 412 and an opposite second side 414. An image element 424 may be printed upon the second side 414, e.g., interlaced slices or strips of a number of images to provide a 3D image, an image with motion, and the like.

The assembly 420 includes a lens array 422 made up of number of lenses (e.g., lenticules) 423, which may be cast or otherwise formed on the first side 412 of the substrate 410 and formed of the same material as the substrate 410 (e.g., polypropylene or another polymer useful for polymer bank notes). This way each lens 423 will have the same refractive index as the substrate 410.

FIG. 4 is useful for showing parameters of a lens 423 that are used to ensure that in-substrate focusing is achieved, as shown with dashed lines 464 indicating focusing of light passing through the lens 423 onto the second or back surface 414 of the substrate 410 and the image element (interlaced images or the like) 424, which is on or abutting the surface/side 414. Particularly, each of the lenses 423 has a chord or base 460 with a width, C, and which mates with or abuts the first side/surface 412 of the substrate 410. Each of the lenses 423 also has a height or sag, H, as measured from the chord/base 460 (or surface/side 412 of the substrate 410) to the top (shown with line 461) of the arc or top of the lens 423. Still further, each of the lenses 423 may be defined by its radius, R, shown with arrow 462 and which represents to radius of the circle defining surfaces of the lens 423.

In order for a lens, such as lens 423, to focus at about 90 microns (e.g., through the substrate 410 to the back side 414 and image element 424), a minimum focus defined by the relationship of the chord width, C, to the focal width, which should be twenty percent of the chord width or 0.2 C at 0 degrees for a relative focus. In this case, the thickness of the substrate (or base polymer), t_{Substrate}, may be defined such as at 70 microns, and the sag or height, H, of the lens (such as lens 423) may be 20 microns (to provide the 90 microns focal distance). For a polymer with a refractive index of about 1.47, which is the refractive index for polypropylene, i.e., a polymer commonly used in polymer bank notes), the minimum lens pitch or frequency can be determined to be determined to be 491 LPI with a refractive index of 1.47, a chord width, C, of 61 microns, and a radius, R, of 35 microns (e.g., a radius of less than 40 microns).

In other words, when calculating the minimum lens pitch possible for a relative focus of less than 0.2C, the pitch equals about 419 LPI with a radius, R, of 35 microns and a sag, H, of 20 microns. When calculating the optimal radius, R (or a desired radius, R), a limit can be recognized or defined by the following height, H, equation: H=R−(R²−C²/R)^{1/2}. In this equation, if the radius calculation ends with a solution where one receives a negative square root, the radius, R, is effectively less than half the width, C, of the chord (such as chord 460 in FIG. 4).

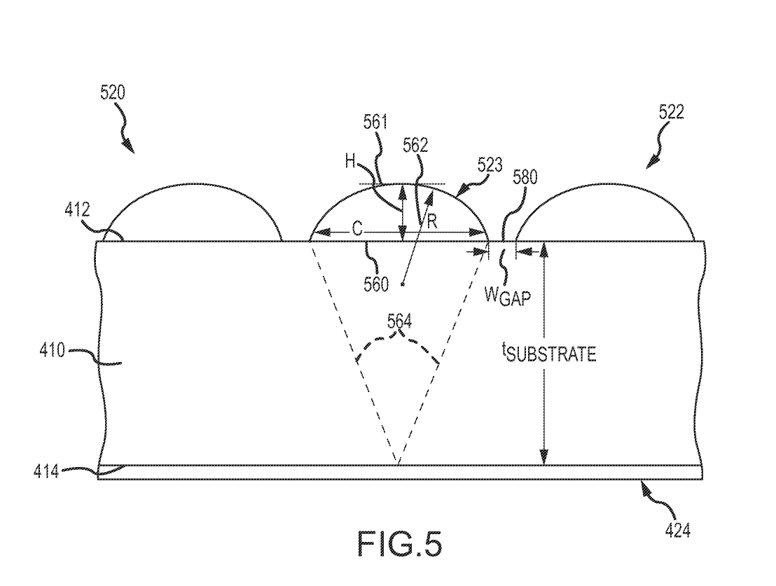

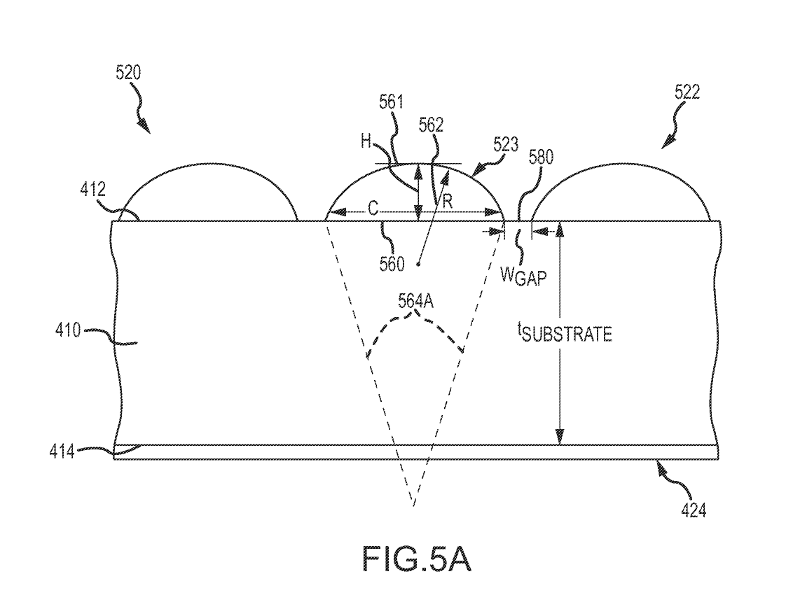

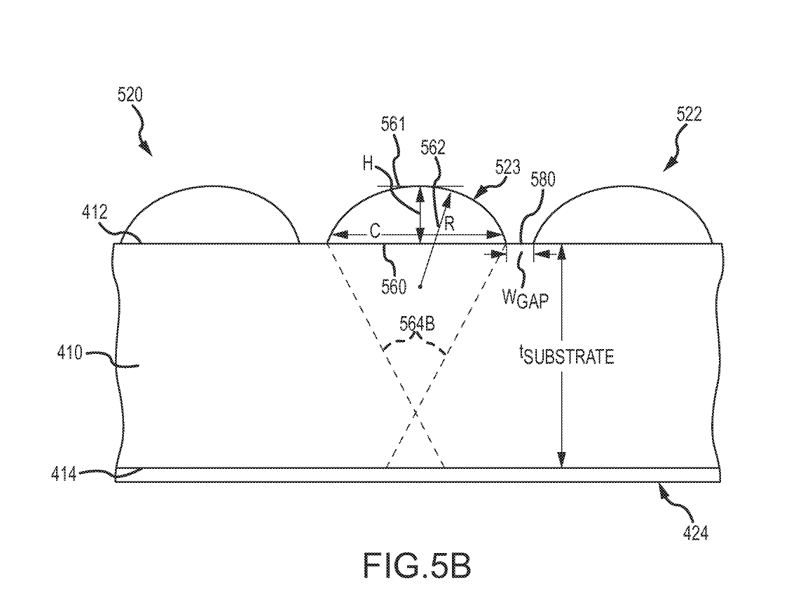

In this case, the inventor recognized that one useful way to make a lens (such as lens 423) focus per the definition of an in-focus lens with the focal width being less than 0.2C (with 0 degrees assumed for this description) is to have gaps or spaces provided between the lenses of the lens array. An embodiment similar to that of FIG. 4 is shown in FIG. 5. In this example, components from the assembly 420 of FIG. 4 that are repeated or shared in optical security assembly 520 are shown with like reference numbers (such as substrate 410).

The assembly 520 includes a lens array 522 that differs from array 422 in that it has a plurality of lenses 523, but a gap or space 580 is provided between each pair of side-by-side or adjacent lenses 523. The gap or space 580 has a width, w_{Gap}, chosen to enhance the focusing of the lenses 523 in-substrate 410 or at second/back surface 414, where the image element 424 is provided. This is shown with dashed lines 564, and line 562 shows the chord of the lens 523 while line 561 shows the top of the lens 523 (with the lens height, H, being measured from chord 560 or surface/side 412 to the top 561 of the lens 523) and arrow 562 shows the radius of the lens' circle.

The inclusion of the gaps or spaces, 580, between adjacent lenses 523 can be used to decrease the height, H, of each of the lenses 523 by artificially keeping a wide data space. This data space is a combination of the width, C, of the chord 560 and half of the width, w_{Gap}, of the gap or space 580 between each pair of adjacent lenses 523. The gaps 580 between the lenses 523 in the lens array 522 may not be ideal, but the gaps 580 can be used as an alternative to an out-of-focus lens (or to achieve in-substrate focusing as shown with dashed lined 564). The lenses 523 will focus, but the chord width, C, can be thought of as artificial in that the lenses per inch calculation is the actual width of the lens 523 plus half of the gap width, w_{Gap}. This effectively lowers the number of lenses per inch but allows the individual lenses 523 to be smaller in chord width, C and focus with a height, H, that is less than 20 microns (i.e., less than the thickness of adjacent ink buildup layers). The interlaced number or LPI of the image element 424 may then be smaller, too, (allowing more data space), but, yet, the lenses 523 will focus on side/surface 414 and image element 424. In the assembly 520 of FIG. 5, there may be noise to the viewer, but this may be acceptable to provide focusing with a lens height, H, of less than 20 microns (e.g., in the range of 12 to 18 microns with 12.5 microns used for H in one prototype).

In the example calculation above, the overall thickness, t_{Note}, of the bank note was assumed to be 90 microns with a substrate having a thickness, t_{Substrate}, of 70 microns. Hence, the thickness, tInk2, of the layers ink and/or other deposited materials on the lens-side or front side of the bank note substrate is 20 microns. Using the equation defined above for lens height or sag, H, and a lens radius of 35 microns, a chord width, C, was determined to be 61 microns. This represents the minimum pitch or frequency with a 1.47 refractive index polymer. It should be noted, though, that as the refractive index increases, the minimum pitch decreases. For example, a refractive index of 1.6 would allow the lens to focus in about 90 percent of the distance (or 10 percent less focal distance) or, stated differently, the effective LPI can be about 10 percent less.

As discussed with regard to the prototype or model designed by the inventor, the minimum pitch in a polymer bank not to achieve an in-focus lens at a 1.47 index of refraction as defined by a focal width of 0.2 C is 419 LPI. The higher limit with the same index of refraction can then be defined as follows. In security printing, maximum dots per inch (DPI) of print devices is currently about 12,800 for offset features. Therefore, in order to have up to 5 pixels in the lens for 3D imaging and maintaining a desired sag, such as less than 20 microns, the maximum pitch (given, typically, in LPI) is defined as: DPI/5=maximum pitch, which with the values provided above gives 12,800/5=2560 LPI.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

For example, the lenses illustrated in the attached figures were circular lenses (e.g., lenticules or linear lenses with a circular cross section), but embodiments of the optical security features or assemblies may be fabricated using elliptical lenses. With an elliptically designed lens, a general focus may be achieved with a small lens height, H (a smaller thickness of the polymer) versus a radius or circular lens design. However, the sag, H, can still be determined in a manner that is similar to that used for straight radius calculations. In this case, focusing with a radius of “X” can be made with a maximum sag, H, of 20 microns.

From the teaching provided herein, one skilled in the art will recognize a number of new features or aspects that may be useful in producing polymer bank notes that are suited for providing security and/or limiting counterfeiting. The bank note may include optical security features or assemblies that include a lens array with a mechanical pitch range across the lens array of between about 419 LPI and 2560 LPI, while the sag or lens height (labeled “H” herein) is kept less than or equal to 20 microns. The lenses may be round lenses, square lenses, hexagonal lenses, or other-shaped lenses rather than linear or lenticular lenses, and, in such cases, the chord in any direction may be equal to or greater than 419 LPI but less than 2560 LPI.

The lenses may be cast in UV polymer, E-beam, or any other energy-cured polymer or solvent or water-based or other coating used to case the structure. The method of extrusion may involve extruding the bank note with a lens array having lenses that are less than 20 microns in height or sag above a side or surface of the base substrate of the bank note and the lens frequency is typically between 419 and 2560 LPI. The interlaced image opposite the lens array is printed on the back side or surface of the substrate with 5 or more pixels across the lens array (regardless of the pixel size).

In some embodiments, the lens frequency or LPI is in the range of 380 to 2560 LPI, with gaps or spaces provided between the lenses in the lens array that allow the lenses to focus at 0 degrees with a focal width of less than 0.2 C as a result of focusing at slightly less or more than a point focus such as plus or minus 0.2 C as shown in FIGS. 5A and 5B with dashed lines 564A and 564B, respectively. Further, such +/−0.2 C focusing may also be provided in the embodiment shown in FIG. 4. In the optical security features or assemblies, the chord width, C, may be kept less than about 58 microns (with or without use of gaps or spaced between adjacent pairs of the lenses in the lens array as shown in FIGS. 4-5B).

I claim:

1. An apparatus for use as a bank note, comprising:
a planar substrate with a first side and a second side opposite the first side, wherein the planar substrate comprises a transparent polymer;
an image stack comprising at least one ink layer applied to the first side of the planar substrate; and
an optical security assembly including a lens array comprising a plurality of lenses on the first side of the planar substrate and extending adjacent to the image stack and further including an image element on the second side of the planar substrate at a location opposite the lens array,
wherein the planar substrate has a thickness and wherein the lenses are each configured to have a focal length corresponding to the thickness of the planar substrate and to focus at the second side upon a portion of the image element.

2. The apparatus of claim 1, wherein the lenses each have a height less than a thickness of the image stack on the first side of the planar substrate.

3. The apparatus of claim 2, wherein the height is less than about 20 microns.

4. The apparatus of claim 3, wherein the height is in the range of 12 to 18 microns.

5. The apparatus of claim 2, wherein the lenses each have a chord width of less than 70 microns.

6. The apparatus of claim 2, wherein the lenses are selected from the group consisting of: round lenses, square lenses, hexagonal lens, elliptical lenses, and lenticules

7. The apparatus of claim 2, wherein the lenses comprise a plurality of lenticules provided at a pitch in the range of 380 to 2560 lenses per inch (LPI).

8. The apparatus of claim 7, wherein the image element comprises a plurality of pixels and wherein each of the lenses is configured to focus on at least five of the pixels.

9. The apparatus of claim 7, wherein the lens array further comprises a gap between each adjacent pair of the lenses and wherein a width of the gap is large enough to provide a relative focus of less than one fifth of a chord width of the lens at 0 degrees.

10. The apparatus of claim 1, wherein the lenses are formed of the transparent polymer and wherein the transparent polymer comprises polypropylene.

11. The apparatus of claim 1, wherein the thickness of the planar substrate as measured between the first and second sides is less than 80 microns.

12. An apparatus for use as a polymer bank note, comprising:
a transparent polymer substrate;
a plurality of layers comprising at least ink applied to a first side of the transparent polymer substrate;
an image element on a second side of the transparent polymer substrate; and
a lens array comprising a plurality of lenses on the first side of the transparent polymer substrate opposite the image element, wherein the lenses each have a sag less than or equal to a combined thickness of the plurality of layers;
wherein the lenses are each configured to focus at the second side of the transparent polymer substrate.

13. The apparatus of claim 12, wherein the sag is less than about 20 microns.

14. The apparatus of claim 13, wherein the sag is in the range of 12 to 18 microns.

15. The apparatus of claim 12, wherein the lenses each have a chord width of less than 70 microns.

16. The apparatus of claim 15, wherein each of the lenses has a radius of less than 40 microns.

17. The apparatus of claim 12, wherein the lenses comprise a plurality of linear lenses provided at a pitch in the range of 380 to 2560 lenses per inch (LPI).

18. The apparatus of claim 12, wherein the image element comprises a plurality of pixels and wherein each of the lenses is configured to focus on at least five of the pixels.

19. The apparatus of claim 12, wherein the lens array further comprises a gap between each adjacent pair of the lenses and wherein a width of the gap is large enough to provide a relative focus of less than one fifth of a chord width of the lens at 0 degrees.

20. The apparatus of claim 12, wherein the thickness of the transparent polymer substrate as measured between the first and second sides is less than 80 microns and the transparent polymer substrate comprises a polypropylene.

21. An apparatus for use as a polymer bank note, comprising:
a transparent polymer substrate having a thickness less than 80 microns;
a plurality of material layers applied to a first side of the transparent polymer substrate with a combined thickness in the range of 10 to 20 microns;
an image element comprising a plurality of printed interlaced images on a second side of the transparent polymer substrate; and
a lens array comprising a plurality of lenses on the first side of the transparent polymer substrate opposite the image element, wherein the lenses each have a height less than or equal to the combined thickness of the plurality of material layers;
wherein the lenses are each configured to focus at the second side of the transparent polymer substrate.

22. The apparatus of claim 21, wherein the lenses comprise a plurality of linear lenses provided at a pitch in the range of 380 to 2560 lenses per inch (LPI).

23. The apparatus of claim 21, wherein the lens array further comprises a gap between each adjacent pair of the lenses.
